(19) United States
(12) Patent Application Publication
(10) Pub. No.: US 2018/0127028 A1
(43) Pub. Date: May 10, 2018

(54) Suspension Adjuster

(71) Applicant: Kevin Joseph McIntyre, Balmain (AU)

(72) Inventor: Kevin Joseph McIntyre, Balmain (AU)

(21) Appl. No.: 15/344,497

(22) Filed: Nov. 4, 2016

(51) Int. Cl. B62D 17/00; B23Q 9/00; F16B 35/04; F16B 39/24

(52) U.S. Cl. CPC B62D 17/00; F16B 39/24; F16B 35/048; B23Q 9/0042

(57) ABSTRACT

A wheel alignment Camber adjuster for a motor vehicle suspension of a popular 2 bolt flange strut comprising a transverse slot which can be in either the top or bottom hole.

Into the slot tab spaces are placed enabling the securing bolt to be placed in set positions of offset. 2 tabs one end of slot or 2 tabs other end or one tab to fill slot on either side of the bolt allows 3 separate adjustment positions. The adjuster is installed by removing one of the 2 bolts that secure the wheel hub. Hub is then swung clear of hole and a drill bit location device is used to allow to drill and convert accurately the round hole into a transverse slot. Hub is then repositioned so bolt can be inserted in place along with the tabs in slot at the required Camber position then nut attached allowing bolt to be fully re-tightened.

### FIELD OF THE INVENTION

This invention relates to a suspension adjuster and has been devised particularly though not solely for adjusting the camber of a motor vehicle wheel supported by a two bolt twin flange strut-type motor vehicle suspension.

### BACKGROUND OF THE INVENTION

Many forms of motor vehicle suspension use a telescopic strut upper end mounted to the body or chassis of the motor vehicle and the lower end provided with a pair of transversely extending parallel flanges (or plates) which typically each extend in a substantially vertical plane and between which is bolted and support the motor vehicle wheel hub assembly. The most common design is called a Chapman 2 bolt flange strut and commonly has a coiled spring engaged coaxially about the strut.

Strut-type suspensions of this nature are very common, particularly on the front suspension of a motor vehicle. However, many forms of such suspensions commonly in use on motor vehicles do not make any, or adequate, provision for camber alignment adjustment of a wheel mounted on the wheel hub. Such adjustment is desirable to correct misalignment due to suspension wear or sagging or to correct minor defects after collision damage has been repaired or after the vehicle suspension has been misaligned following impact with an object such as a curb or pothole. If the camber adjustment on a motor vehicle is not correct, steering problems may result and tire wear becomes significant.

Currently a previous US patent describes a method where one of the 2 existing bolts is replaced by a smaller diameter bolt. This difference is used as the means to gain this amount of offset adjustment at the stub axle plus pivoting of the other locating bolt thereby changing the vehicles camber/tire contact area.

This design of the adjustment range is dependent on reducing one of these 2 critical OEM specified bolt diameters that hold the stub axle wheel assembly. Adjustment range is minimal and the design does not allow for secure locking in position.

Another method is my (Kevin McIntyre) US patent which allows twice or more adjustment range of the previously mentioned invention/patent by boring the actual flange hole larger and allows existing OEM diameter bolts to be used.

### OBJECT OF THE INVENTION

This new innovative design described here in the present application overcomes and substantially ameliorates the shortcomings of the previously mentioned designs using undersize bolts or requiring extra large holes to be bored, insufficient adjustment and not a positive locking system.

### DESCRIPTION OF THE INVENTION IN CONJUNCTION WITH THE DRAWINGS

Notwithstanding any other forms that may fall within its scope, one preferred form of the invention will now be described to the accompanying drawings wherein:

FIG. 1 is a perspective view of the lower end of a twin flange ‘Chapman” strut-type motor vehicle suspension showing the upper (or can be lower) mounting bolt removed and the wheel hub support member pivoted downwardly for engagement of a wheel alignment adjuster according to the invention.

FIG. 2 is a view of 2 tab spacers incorporated for convenience each tab into its own slotted washer.

FIG. 3 is a view of these 2 tab washers as shown in FIG. 2 but now one is reversed showing how tabs can also be at opposite to each other.

FIG. 4 is a view showing the 2 tab washers being placed now on top of each other, with tabs sufficient length to enter the new slot provided in the strut flange. This 2 plate combination allows therefore 2 tabs to be placed at either end of slot or one tab at either end. Allowing 3 separate bolt positions and therefore alignment positions.

FIG. 5 is a side view of the wheel alignment adjuster assembly.

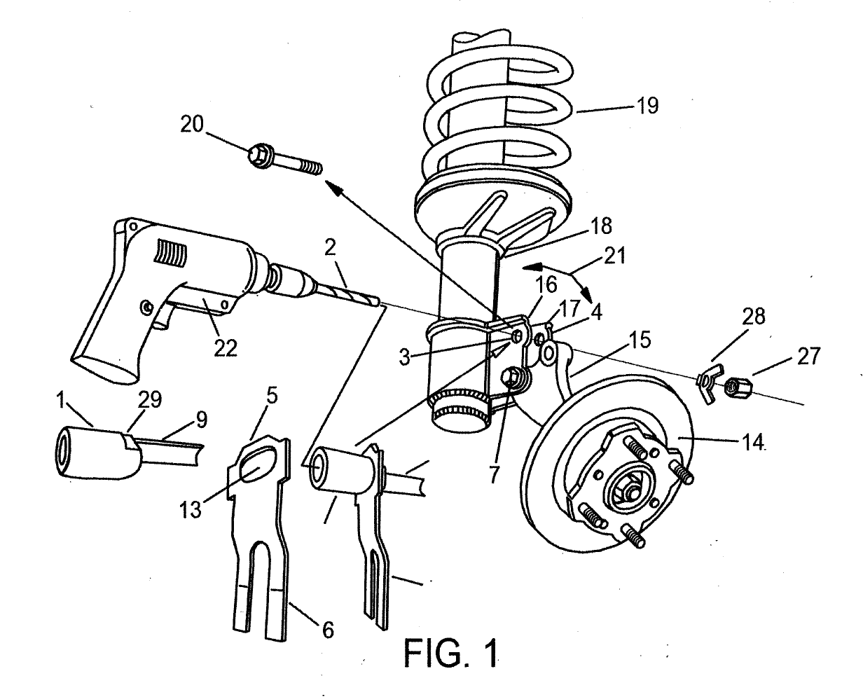

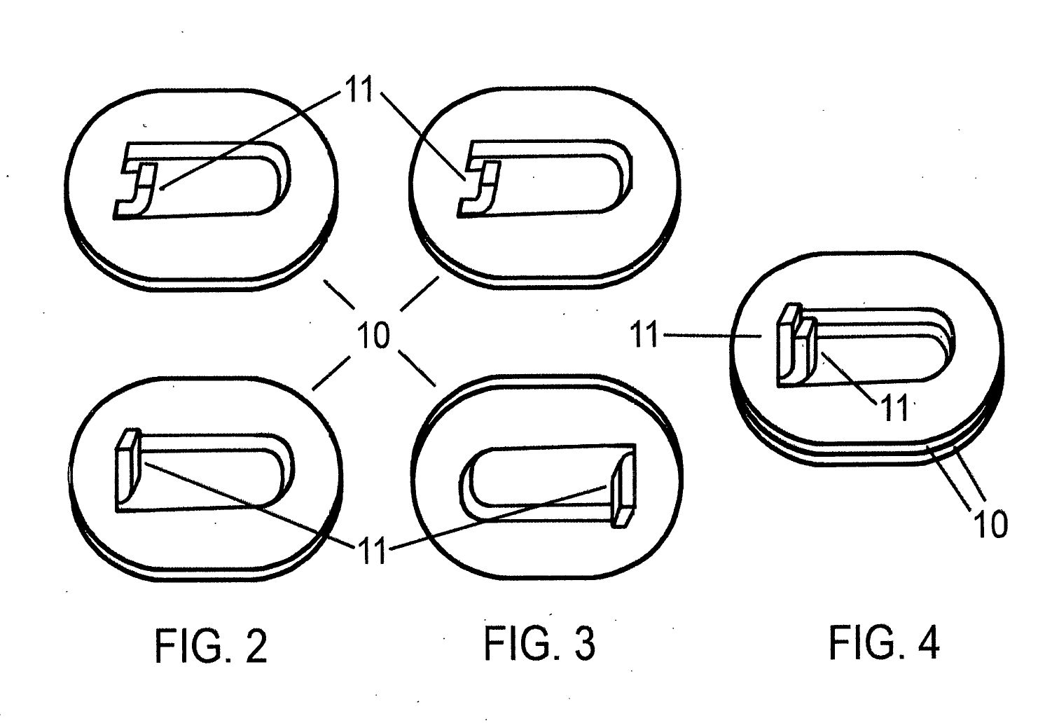

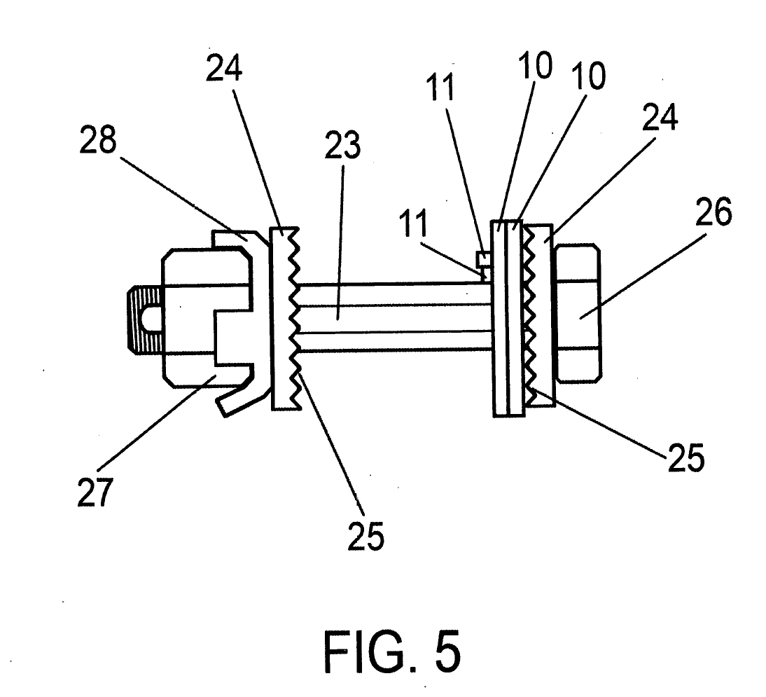

In the preferred form of the invention a camber adjuster is provided for a motor vehicle suspension having a strut 18 typically with a coaxial coil spring 19 and pair of parallel flanges 16 and 17 between which is mounted a support 15 for a motor vehicle hub 14. This support 15 is normally bolted between the flanges by way of a bolt 20 through aligned holes 3 and a lower bolt 7. To use the adjuster according to the invention the upper bolt 20 (or lower bolt 7) is removed as shown in FIG. 1 and the wheel hub pivoted as indicated by arrow 11 to the position shown in FIG. 1 leaving aligned aperture free. The aperture in both flanges 16 and 17 are then slotted horizontally by way of a drill bit in a power drill 22 using the drill bit location devise 11 which is secured so slot extension is drilled horizontally being secured in slotted hole 13 in plate 5 in FIG. 1. Assembly of the wheel alignment adjuster is as shown in FIG. 5 using the tab spacers 11 which can be incorporated in slotted washers 10 as illustrated in FIGS. 2, 3 and 4 or by other suitable means. Actual assembly in FIG. 5 shows a ‘D’ shape or splined bolt 23 with washers 24 that also have a one matching ‘D’ or splined hole that preferably one can be placed under bolt head 26 and the other at nut end 27. Teeth 25 can be included on inner face so that when bolt assembly is tightened more secure locking takes place. In addition a lock tab can be included 28 directly behind the nut also with the matching ‘D’ or splined centre hole so that it also engages the bolt. Once nut is fully tightened one only of the 3 tabs will match a face of the hexagon nut. This tab is then folded alongside the nut face to fully secure nut against loosening.

(a) A drill bit location device is provided 1.

(b) Similar size drill bit 2 to the existing flange hole size 3.

(c) Allowing it to be bored through the flange 4 in an offset position.

(d) The offset position is maintained while drilling by an extension of the drill location 9.

(e) Can be of different thickness but preferably would be half the size of the existing hole 3 with preferably the inside matching the radius of the drill 2.

(f) The lug 9 maintains straightness of the drill with it extending through to the hole in the rear flange enabling it also to be drilled accurately.

(g) Effectively now the front and rear flange holes are now slotted.

(h) In order that the slots are drilled or formed horizontally the actual drill location device may have a handle or a means to retain the drill device from moving from horizontal whilst drilling.

(i) One method that may be utilised is a plate 5 having a pair of legs 6 designed to be secured under or to pass either side of the existing other bolt 7 in a strut having a 2 bolt flange.

(j) With the drill device having a matching parallel flat section 29 allowing it to be securely located in a slotted hole 13. at the other end of this plate advantageously there would be no need for one hand to hold the device horizontal while drilling to ensure the hole being slotted horizontal.

(k) The bolt is held in the new position by tabs 11 placed in the slot FIG. 2, 3, 4. For example if a 12 mm in diameter bolt the hole may be bored six mm offset so that the slot is 18 mm long. If the tabs are 3 mm each thick . . . 2 tabs side by side (ie, six mm thick) means the bolt is at maximum offset or 2 tabs side by side on the other side of the bolt means no offset.

(l) Effectively, this design offers 3 times the adjustment travel of the previous invention/patent as in practice this normal reduction in bolt diameter is 2 mm.

(m) Further, this new invention is not a rotational, cam type adjustment so it is not subject to slippage or kerb knock damage.

(n) Placement of these tab spacers may be facilitated by any means. One suggested method is by including the tabs in a slotted washer 10. (FIG. 2, 3, 4).

(o) Two washers may be used with one tab in each washer the washers having a slot 12 similar in length to the actual flange slot.

(p) Each tab 11 is positioned at the end of one slot with the tab protruding at 90 degrees to the washer face.

(q) The washers may be placed one on top of the other with both tabs protruding down into the flange slot.

(r) If the washers are stacked so both tabs are at one end means the bolt is located fully at opposite end of the slot.

(s) If the washers are placed so that one tab is at one end and the other tab is at the opposite end means the bolt is at the middle of the slot.

(t) Having both tabs at the other end means the bolt is now fully 100 offset the other direction.

(u) For additional slot length the drill jig may include a spacer so that the other end of the slot is drilled out the same length extending the bolt travel . . . this necessitates the inclusion of extra tab spacer to retain the location.

Although preferred embodiments of the invention may have been described in detail and with reference to specific examples, it should be appreciated and understood that various changes; substitutions and alterations may be made herein by those of ordinary skills in the relevant arts/s without departing from the no spirit or scope of the present invention and that it may be embodied in other forms.

The invention may also be said broadly to consist in or of parts, elements and features as illustrated and or referred to in the description of the invention, individually or collectively, in any or all combinations of parts or a plurality of said parts, elements or features.

It should be noted that the invention maybe formed from different natural or synthetic materials, for example metals or plastics. Different components of the inventory may be made of different materials in order to provide desired properties of strength and rigidity etc.

Where specific integers are mentioned which have known equivalents in the arts/s to which the invention relates, such known equivalents are deemed to be incorporated as if individually set forth.

Features defining the invention include all the aspects set forth above in the description and illustrated in the drawings.

The inventor asserts his moral rights to be recognised as the creator and owner of this invention and design and the Intellectual Property therein together with copyright in this description and illustrations.

What is claimed is:

1. A suspension adjuster for modifying a twin-flange strut vehicle suspension to permit camber adjustment, the suspension having spaced, parallel flanges each extending in substantially vertical planes transversely directed relative to the vehicle, and wherein a vehicle hub mounting arm has an upper end portion located between the flanges and is fixed by upper and lower bolts passing through respective aligned bores in the flanges and the mounting arm, the suspension adjuster being adopted to be applied after removal of one of the suspension bolts and slotting of one of the circular diameter holes in the flange.

2. The suspension adjuster comprising drill guide with a pilot hole similar in diameter to one of the 2 existing flange holes

3. A semi circular extension to this drill guide preferably half the diameter of the existing hole enabling it to locate inside one face of a flange hole

4. A further extension of this drill guide enabling it to pass through a flange hole and then into the rear flange allowing therefore accurate guidance of the drill when elongating, slotting the existing front and rear round flange holes.

5. Means for restraining the drill guide to ensure accuracy of having horizontal, transverse slotted holes.

6. Suspension adjuster as claimed in claim 1. whereby a single or 2 legged slotted plate is provided enabling the 2^{nd} remaining bolt to clamp down on or the 2 legs to pass either side of the bolt securing the plate thereby in a stationery position with the upper portion having a slot horizontally. Into which is inserted the drill guide which has matching parallel surfaces to engage this slot and therefore secure the drill guide from rotating while drilling.

7. A suspension adjuster as claimed in claim 1. whereby spacer tabs are placed in slot preferably two designed to fill along with the bolt diameter the remaining void in slot. Alternatively two tabs on the other side or one tab either side of the bolt means effectively 3 positions of bolt offset and therefore camber change is provided.

8. A suspension adjuster as claimed in claim 1. whereby the spacer tabs for ease of insertion in slot are included in a slotted washer. This washer having a single tab protruding at 90 degree angle from one end of slot. Two of these washers can therefore be combined one on top of the other with tab length sufficient to enter the flange slot. Inserting into slot with both tabs one end or both other end or one tab at either end means again the 3 positions of camber adjustment available.

9. A suspension adjuster as claimed in claim 1. whereby the adjuster included front and rear washers which lay under bolt head and under nut end with sharp protruding teeth extending from the washers to bite into the outer faces when the nuts are tightened.

10. A suspension adjuster as claimed in claim 1. Whereby the bolt has a full length spline or flat so that matching shape holes in the tooth washers under bolt head and nut engage bolt preventing from rotating independently.

11. A suspension adjuster as claimed in claim 1. Whereby a lock tab is included directly under nut. This lock tab having a centre hole to match also and engage the spline or ‘D’ shape bolt. This washer then having preferably 3 tabs so positioned that upon tightening the nut one of these tabs will match and line up with a flat side of the hexagon nut. This tab is then folded at 90 degrees so nut is prevented from loosening.
